(19) United States
(12) Patent Application Publication
(10) Pub. No.: US 2014/0261286 A1
(43) Pub. Date: Sep. 18, 2014

(54) MODULAR STRUCTURE SUPPORTING ENGINE ENCLOSURE

(71) Applicant: CATERPILLAR INC., Peoria, IL (US)

(72) Inventors: Robert J. Madera, Lemont, IL (US); Joshua C. Bedyk, Sandwich, IL (US); John M. Teter, North Aurora, IL (US)

(73) Assignee: Caterpillar Inc., Peoria, IL (US)

(21) Appl. No.: 13/846,426

(22) Filed: Mar. 18, 2013

(51) Int. Cl. F02B 77/00; B23P 19/04

(52) U.S. Cl. CPC F02B 77/00; B23P 19/04
USPC 123/195 R; 29/888.01

(57) ABSTRACT

A modular structure is provided. The modular structure may be detachably mounted on an engine enclosure. The modular structure includes a first section and a second section. The first section is configured to house at least one of an aftertreatment module and a muffler module. The second section is configured to house an air cleaner module. At least one of the first section and the second section is configured to be detachable from the engine enclosure to provide access to an engine within the engine enclosure.

### TECHNICAL FIELD

The present disclosure relates to a modular structure and more particularly to the modular structure mountable over an engine enclosure.

### BACKGROUND

A variety of modules or subsystems are associated with an engine. These modules may include, for example, an aftertreatment module, a muffler module, an air cleaner module, and the like. Typically, these modules are located proximate to the engine within an engine enclosure. Due to limited space provided within the engine enclosure, such a design may provide reduced access to the engine. Accessibility issues may in turn cause high installation and removal time for servicing the engine.

One solution included mounting these modules above the engine enclosure, in order to create more space within the engine enclosure. For example, U.S. Published Application No. 2012/0227376 relates to a work machine provided with an aftertreatment device. The aftertreatment device is located above the engine and supported by a carriage releasably connected to a frame for independent removal of the aftertreatment device.

However, known solutions did not address the issue of the time incurred in removal and reinstallation of the engine from within the engine enclosure. Longer servicing time causes increased downtime of the engine, affecting the overall performance of the system. Hence, there is a need to provide an improved design to address the abovementioned shortcomings.

### SUMMARY OF THE DISCLOSURE

In one aspect of the present disclosure, a modular structure is provided. The modular structure may be detachably mounted on an engine enclosure. The modular structure includes a first section and a second section. The first section is configured to house at least one of an aftertreatment module and a muffler module. The second section is configured to house an air cleaner module. At least one of the first section and the second section is configured to be detachable from the engine enclosure to provide access to an engine within the engine enclosure.

In another aspect, a method is provided. The method detachably mounts a modular structure on an engine enclosure. The method provides at least one of an aftertreatment module and a muffler module within a first section of the modular structure. The method provides an air cleaner module within a second section of the modular structure. The method detaches at least one of the first section and the second section of the modular structure from the engine enclosure to provide access to an engine within the engine enclosure.

Other features and aspects of this disclosure will be apparent from the following description and the accompanying drawings.

### BRIEF DESCRIPTION OF THE DRAWINGS

FIG. 1 is a diagrammatic view of an exemplary machine having a modular structure located above an engine enclosure, according to one embodiment of the present disclosure;

FIG. 2 is a perspective view of the modular structure;

FIG. 3 is a perspective view of the modular structure mounted on the engine enclosure;

FIG. 4 is an another perspective view of the modular structure mounted on the engine enclosure; and

FIG. 5 is a flowchart of an exemplary method for mounting the modular structure on the engine enclosure.

### DETAILED DESCRIPTION

Wherever possible the same reference numbers will be used throughout the drawings to refer to the same or the like parts. FIG. 1 illustrates an exemplary machine 100 according to one embodiment of the present disclosure. As illustrated, the machine 100 may embody a large wheel loader. Alternatively, the machine may include, but not limited to, a backhoe loader, a skid steer loader, a track type tractor, a motor grader, and the like. It should be understood that the machine 100 may embody any wheeled or tracked machine associated with mining, agriculture, forestry, construction, and other industrial applications.

Further, the machine 100 may include an operator cabin 102 and a lifting assembly 104. The operator cabin 102 may include a plurality of input devices configured to control and operate the machine 100. The lifting assembly 104 may include a lifting arm 106, a support arm 108 and a bucket 110. The bucket 110 of the lifting assembly 104 may be configured to collect, hold and convey any material and/or object on a ground 112. A hydraulic system (not shown) may be used to effectuate the movement of the lifting arm 106, the support arm 108 and/or the bucket 110 of the lifting assembly 104. A transmission system (not shown in figures) may include coupling elements configured to transmit a drive torque from an engine to a propelling system. The propelling system may include a plurality of wheels 114 driven by a differential gearing for propelling the machine 100 on the ground 112.

Additionally, the machine 100 may include a frame 116 and an engine enclosure 118 mounted on the frame 116. The engine may be housed within the engine enclosure 118 of the machine 100. The engine may generate the necessary driving power required by the machine 100. In one embodiment, the engine may include, for example, a diesel engine, a gasoline engine, a gaseous fuel powered engine like a natural gas engine, or any other known source of power.

The present disclosure relates to a modular structure 120 that may be detachably mounted on the frame 116 of the machine 100, more particularly above or atop the engine enclosure 118. FIG. 2 illustrates a perspective view of the modular structure 120. In one embodiment the modular structure 120 may be made from a suitable metal, such as, for example, an alloy of steel, aluminum, and the like. Alternatively, any other non-metallic material may be used. The material may be selected based on factors like strength, lower weight, cast-ability, machinability, etc.

Referring to FIG. 2, the modular structure 120 may include a first section 202 and a second section 204 that may be detachably mounted on the engine enclosure 118. In one embodiment, the first section 202 of the modular structure 120 may be configured to house at least one of an aftertreatment module and a muffler module. The second section 204 of the modular structure 120 is configured to house an air cleaner module. One of ordinary skill in the art will appreciate that the modular structure 120 allows for the aftertreatment module and/or the muffler module as well as the air cleaner module to be detachably placed above the engine enclosure 118. This may result in increased space within the engine enclosure 118 and may further provide improved access for servicing the engine. Accordingly, as shown in FIG. 1, the modular structure 120 may be preferably located proximate to a service ladder 122 to facilitate in ease of access for removal and/or installation.

The design of the modular structure 120 will now be described in detail. As illustrated in FIG. 2, the first section 202 of the modular structure 120 may include a rib structure 206. The rib structure 206 of the first section 202 may include a plurality of channels 208 configured to interconnect with each other in order to define the rib structure 206 and provide required support for the modular structure 120. The plurality of channels 208 can be placed in substantially vertical and horizontal orientations. Moreover, the plurality of channels 208 may be interconnected to each other by way of fastening, riveting, welding, or any combination thereof.

Referring to FIG. 3, the rib structure 206 may be enclosed by a plurality of side walls 302 and a top surface 304. It should be noted that a bottom portion of the first section 202 may be housed directly above an opening on the frame 116 of the machine 100, the opening providing access to the engine within the engine enclosure 118. The bottom portion may be designed in order to allow for necessary connections required between the aftertreatment module and/or the muffler module with other components within the engine enclosure 118.

Further as illustrated in FIG. 3, the top surface 304 of the first section 202 may include one or more apertures. The aperture is configured to receive an exhaust stack 124 associated with the aftertreatment module housed within the first section 202. In one example, provision to house two exhaust stacks 124 is provided on the top surface 304. In one embodiment, the top surface 304 may be detachably mounted on the first section 202 by suitable mechanical fasteners known in the art, such as a nut and bolt assembly. Removal of the top surface 304 may provide ease of access to the aftertreatment module and/or the muffler module.

As illustrated in FIG. 2, the modular structure 120 may include a separation member 210 configured to define the first section 202 and the second section 204 within the modular structure 120. In one embodiment, the separation member 210 may include at least one opening to allow for required connections between the components housed in the first section 202 and the second section 204. Further, the second section 204 of the modular structure 120 is configured to house the air cleaner module and/or a shunt tank. A bottom portion of the second section 204 may include an opening in communication with the components within the engine enclosure 118. Necessary connections between the air cleaner module and the components within the engine enclosure 118 may be made through the opening.

The second section 204 of the modular structure 120 may include a plurality of side walls 212 and a top surface 214. In one embodiment, the second section 204 may also be supported by a rib structure enclosed within the plurality of side walls 212 and the top surface 214. The top surface 214 of the second section 204 may include a plurality of apertures in order to receive a pre-cleaner 126. For example, in the accompanying figures, four pre-cleaners 126 are shown atop the second section 204 of the modular structure 120.

Moreover, in one embodiment, the top surface 214 of the second section 204 may be detachably coupled to the second section 204 in order to provide access to the air cleaner module. The coupling may be provided by bolting or any other known method. Parameters of the first section 202 and the second section such as height, length, and the like may vary based on system requirements. In the accompanying figures the height of the second section 204 is comparatively lesser than that of the first section 202 specific to the machine requirements. Moreover, in one embodiment, any one of the side walls 302, 212 of the first section 202 and/or the second section 204 may be formed by the components placed adjacent to the modular structure 120. One of ordinary skill in the art will appreciate that though the modular structure 120 shown in the accompanying figures is box shaped with primarily horizontal and vertical parts relative to the ground, the modular structure 120 could be tapered or shaped in some instances where the shape may improve the rearward visibility of the operator.

The first section 202 and the second section 204 of the modular structure 120 may be detachably connected to each other. This detachable coupling may be provided in such a manner so as to allow any one of the first section 202 or the second section 204 to be uninstalled from the frame 116 of the machine 100. In another exemplary embodiment, both the first section 202 and the second section 204 may be uninstalled from the frame 116 of the machine 100. More particularly, one or more lifting points (not shown) may be present on the modular structure 120. These lifting points may be connected with a metal chain sling, a nylon lifting sling, or any other known lifting strap in order to dismantle or remove the modular structure 120 from the frame 116 of the machine 100. It should be noted that the design of the modular structure 120 is such that removal of the entire first section 202, the entire second section 204 and/or the particular walls 212, 302 or the surfaces 214, 304 may be possible.

FIGS. 3 and 4 illustrate an exemplary way of detachably mounting the modular structure 120 on the frame 116 of the machine 100. As shown, the engine enclosure 118 may include a plurality of channels 306 placed in substantially vertical and horizontal orientations. Additionally, the engine enclosure 118 may also include a plurality of doors 308 configured to provide access to the engine of the machine 100. In one exemplary case, the doors 308 may have a double hinged configuration. Referring to FIG. 4, the vertically placed channel 306 may be provided with a plurality of mounts 402 configured to mount the modular structure 120 onto the engine enclosure 118. As discussed earlier, the engine enclosure 118 in turn is mounted on the frame 116 of the machine 100.

The first section 202 and/or second section 204 of the modular structure 120 may be detachably coupled to the plurality of mount 402 by means of a fastening assembly. The fastening assembly may include, for example, a nut and bolt assembly or the any other mechanical fastener. As shown in FIG. 4, the bolt may pass through the horizontal channel 208 of the rib structure 206 of the first section 202 and also through the mount 402 provided on the channel 306 of engine enclosure 118. It should be noted that the positioning of the mounts 402 and the selection of the fastening assembly may be provided in such a manner so as to allow easy access in order to facilitate relatively low removal and installation time.

A method 500 for mounting the modular structure 120 on the engine enclosure 118 will be explained in connection with FIG. 5.

### INDUSTRIAL APPLICABILITY

Generally, the aftertreatment module, the muffler module and the air cleaner module are mounted within the engine enclosure of the machine. In such systems, the entire assembly of the aftertreatment module and/or the air cleaner module needs to be removed in order to service or provide access to the engine. This may result in relatively higher servicing time as well as the installation time. Further, the down time of the work in progress caused by the higher servicing time and installation time can lead to cost consideration issues.

The modular structure 120 of the present disclosure provide for the independent removal of any one or both of the first section 202 and the second section 204 from the frame 116 of the machine 100. This may provide improved accessibility to the engine as well as other parts associated with the engine, for example, a pump bay which may be located below the second section 204 of the modular structure 120. Also, since the modular structure 120 is mounted to the engine enclosure 118 through the fastening assembly, the modular structure 120 can be readily and easily separated from the engine enclosure 118. Reduced removal and installation time may further enable quick servicing of the engine. Placement of the aftertreatment module, the muffler module or the air cleaner module atop the engine enclosure 118 may assist in reducing space constraints within the engine enclosure 118.

Further, in one exemplary embodiment, the modular structure 120 of the present disclosure provide for the removal of the top surface 304 of the first section 202 in order to access the aftertreatment module and/or the muffler module for servicing purpose. In another exemplary embodiment, the top surface 214 of the second section 204 may be removed in order to access the air cleaner module for servicing. Further, one or more doors may be provided on any one wall of the second section 204 in order to directly access the filter elements. The doors may be positioned in such a manner that the doors and the filter elements can be reached while standing on the primary machine platform.

The location and positioning of the modular structure 120 may be such that the modular structure 120 is accessible from the service ladder 122 of the machine 100, in order to allow ease of removal or installation. Additionally, the doors 308 of the engine enclosure 118 provided below the modular structure 120 may provide easy access to the engine.

At step 502, the modular structure 120 may be detachably mounted on the engine enclosure 118. This may include the mounting of the first section 202 and the second section 204 above the engine enclosure 118. At step 504, the first section 202 of the modular structure 120 may be provided with at least one of the aftertreatment module and the muffler module. Thereafter, the aftertreatment module may be connected to an exhaust system of the engine of the machine 100.

At step 506, the second section 204 of the modular structure 120 may be provided with the air cleaner module. Thereafter the air cleaner module may be connected to an intake system of the engine. The air cleaner module may be in communication with the pre-cleaner 126 placed atop the second section 204. At step 508, at least one of the first section 202 and the second section 204 of the modular structure 120 may be detached from the engine enclosure 118 in order to provide access to the engine located in the engine enclosure 118.

In one exemplary embodiment, any one of the first section 202 and the second section 204 may be detached from the engine enclosure 118 in order to access the engine located within the engine enclosure 118. Alternatively, in another exemplary embodiment, both of the first section 202 and the second section 204 may be detached from the engine enclosure 118. Also, the removal of any one or both of the first section 202 and the second section 204 may facilitate in the servicing of the aftertreatment module, muffler module or the air cleaner module housed within the modular structure 120.

The present disclosure has been explained with reference to the aftertreatment module housed in the first section 202 and the air cleaner module housed in the second section 204. However, the present disclosure does not restrict itself to aftertreatment module and the air cleaner module. A person of ordinary skill in the art will appreciate that the first section 202 may include any other component and/or module associated with the engine of the machine 100.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A modular structure detachably mounted on an engine enclosure, the modular structure comprising:
a first section configured to house at least one of an aftertreatment module and a muffler module; and
a second section configured to house an air cleaner module;
wherein at least one of the first section and the second section is configured to be detachable from the engine enclosure to provide access to an engine within the engine enclosure.

2. The modular structure of claim 1, wherein a top surface of the first section is configured to receive an exhaust stack.

3. The modular structure of claim 1, wherein a top surface of the second section is configured to receive a pre-cleaner.

4. The modular structure of claim 1 further comprising a separation member disposed within the modular structure, the separation member configured to define the first section and the second section.

5. The modular structure of claim 1, wherein the modular structure is made of metal.

6. The modular structure of claim 1 further comprising a plurality of mounts provided on the frame of the machine, wherein a lower surface of the modular structure is configured to be affixed to the plurality of mounts.

7. The modular structure of claim 1, wherein the second section is detachably coupled to the first section.

8. A method comprising:
mounting, detachably, a modular structure on an engine enclosure;
providing at least one of an aftertreatment module and a muffler module within a first section of the modular structure;
providing an air cleaner module within a second section of the modular structure; and
detaching at least one of the first section and the second section of the modular structure from the engine enclosure to provide access to an engine within the engine enclosure.

9. A machine comprising:
an engine;
a frame;
an engine enclosure provided on the frame of the machine, the engine enclosure configured to house the engine; and
a modular structure detachably mounted on the engine enclosure, the modular structure comprising:
a first section configured to house at least one of an aftertreatment module and a muffler module; and
a second section configured to house an air cleaner module;
wherein at least one of the first section and the second section is configured to be detachable from the engine enclosure to provide access to the engine within the engine enclosure.

10. The machine of claim 9, wherein a top surface of the first section is configured to receive an exhaust stack.

11. The machine of claim 9, wherein a top surface of the second section is configured to receive a pre-cleaner.

12. The machine of claim 9 further comprising a separation member disposed within the modular structure, the separation member configured to define the first section and the second section.

13. The machine of claim 9, wherein the modular structure is made of metal.

14. The machine of claim 9 further comprising a plurality of mounts provided on the frame of the machine, wherein a lower surface of the modular structure is configured to be affixed to the plurality of mounts.

15. The machine of claim 9, wherein the second section is detachably coupled to the first section.
